(19) United States
(12) Patent Application Publication
(10) Pub. No.: US 2013/0271569 A1
(43) Pub. Date: Oct. 17, 2013

(54) STEREOSCOPIC MOVING PICTURE GENERATING APPARATUS AND STEREOSCOPIC MOVING PICTURE GENERATING METHOD

(71) Applicant: Fujitsu Limited, Kawasaki-shi (JP)

(72) Inventor: Toshiro OHBITSU, Akishima (JP)

(21) Appl. No.: 13/912,589

(22) Filed: Jun. 7, 2013

Related U.S. Application Data
(63) Continuation of application No. PCT/JP2010/072281, filed on Dec. 10, 2010.

(51) Int. Cl. H04N 13/00

(52) U.S. Cl. CPC H04N 13/004
USPC 348/43

(57) ABSTRACT

A stereoscopic moving picture generating apparatus includes a storage unit to store a first dynamic image containing images, a second dynamic image containing images, each associated with the timing information, and a predetermined image; and an arithmetic unit to extract a first image of the first dynamic image and a second image of the second dynamic image, which are associated with the same timing information, and the predetermined image from the storage unit, calculate a first position as an existing position of the predetermined image in the first image, calculate a second position as that of the predetermined image in the second image, calculate a first quantity as a difference between the first and the second position, move at least one of the first and the second position in parallel based on the first quantity, and thus generate a new first image and a new second image.

### CROSS-REFERENCE TO RELATED APPLICATION

This is a continuation of Application, filed under 35 U.S.C. §111(a) of International Application PCT/JP2010/072281, filed on Dec. 10, 2010, the contents of which are herein wholly incorporated by reference.

### FIELD

The present invention relates to a stereoscopic moving picture generating apparatus, a moving picture generating method and a moving picture generating program.

### BACKGROUND

There is a moving picture generating apparatus for generating images that can be stereoscopically viewed by making use of a parallax between the images captured by two cameras adjacent to each other. The moving picture generating apparatus generates and displays the image captured by one camera as an image for a left eye and the image captured by the other camera as an image for a right eye in the images captured by the two adjacent cameras, thereby making a viewer perceive the stereoscopic image.

With respect to the same physical object, a difference between a position in the image for the left eye and a position in the image for the right eye is referred to as a parallax. When parallax quantities are different between two physical objects existing within the image (picture), one physical object appears to exist nearer or farther than the other physical object. The parallax quantity is defined as a magnitude of the parallax.

FIG. 1 is a diagram illustrating an example of the stereoscopic picture. In FIG. 1, an image 910 is an image for a left eye, and an image 920 is an image for a right eye. Herein, an object A, an object B and an object C exist in each of the image 910 as the image for the left eye and the image 920 as the image for the right eye. Due to parallaxes of these objects between the image 910 and the image 920, a person looking at the stereoscopic picture in FIG. 1 views the object A, the object B and the object C as if existing in this sequence from the near side.

### DOCUMENTS OF PRIOR ARTS

### Patent Document

[Patent document 1] Japanese Patent Application Laid-Open Publication No.2008-92555
[Patent document 2] Japanese Patent Application Laid-Open Publication No.2000-78611
[Patent document 3] Japanese Patent Application Laid-Open Publication No.2004-207773

### SUMMARY

On the occasion of viewing the dynamic images (moving picture), it often happens that a viewer's attention is focused on a physical object with a motion. In the stereoscopic picture (stereoscopic moving picture) that makes use of parallaxes of the dynamic images captured by the two adjacent cameras, a parallax quantity of the moving physical object exhibits almost no change even when moving in right-and-left directions and in up-and-down directions. This is because the parallax quantity of this physical object depends on a distance between the camera and the physical object. In this case, the viewer is hard to suffer eye fatigue. If this moving physical object moves in a depthwise direction, however, the parallax quantity of the physical object changes. The viewer, if viewing this type of dynamic images (moving picture) for a long period of time, gets easy to suffer the eye fatigue.

Further, even when the parallax quantity of the moving physical object on which the attention is focused is adjusted temporarily to become zero, the distance between the moving physical object on which the attention is focused and the camera varies, and the parallax quantity of this physical object is thereby changed, with the result that the viewer gets easy to suffer the eye fatigue.

Hence, in the stereoscopic moving picture, it is required to relax the change in parallax quantity of the moving physical object on which the attention is focused. For example, in the stereoscopic moving picture, it is required to adjust the parallax quantity of the physical object on which the attention is focused to be smaller than a predetermined value.

The stereoscopic moving picture generating apparatus of the disclosure adopts the following means in order to solve the problems given above.

Namely, according to one aspect of the disclosure, a stereoscopic moving picture generating apparatus includes: a storage unit to store a first dynamic image containing a plurality of images each associated with timing information, a second dynamic image containing a plurality of images each associated with the timing information, and a predetermined image; and an arithmetic unit to extract a first image of the first dynamic image and a second image of the second dynamic image, which are associated with the same timing information, and the predetermined image from the storage unit, calculate a first position as an existing position of the predetermined image in the first image, calculate a second position as an existing position of the predetermined image in the second image, calculate a first differential quantity as a difference between the first position and the second position, move at least one of the first position of the predetermined image in the first image and the second position of the predetermined image in the second image in parallel on the basis of the first differential quantity, and thus generate a new first image and a new second image.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a stereoscopic picture.

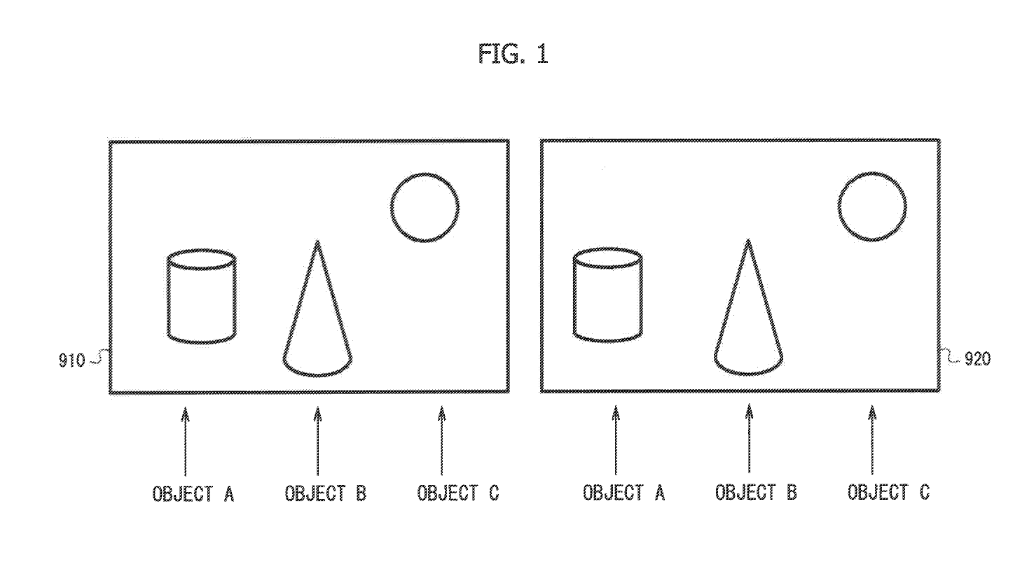

FIG. 2 is an explanatory diagram of a parallax in the stereoscopic picture.

FIG. 3 is a diagram illustrating an example of a structure of MPEG-2 formatted data.

FIG. 4 is a diagram illustrating a relationship between an I-picture, a P-picture and a B-picture.

FIG. 5 is a diagram illustrating an example of a stereoscopic moving picture generating apparatus.

FIG. 6 is a diagram illustrating an example of a hardware configuration of an information processing apparatus.

FIG. 7 is a flowchart depicting an example (1) of an operation flow of the stereoscopic moving picture generating apparatus.

FIG. 8 is a flowchart depicting an example (2) of the operation flow of the stereoscopic moving picture generating apparatus.

FIG. 9 is an explanatory diagram of a process in step S104.

FIG. 10 is an explanatory diagram of a process in step S107.

### DESCRIPTION OF EMBODIMENTS

Embodiment will hereinafter be described with reference to the drawings. Configurations of the embodiments are exemplifications, and the present invention is not limited to the configurations of the embodiments of the disclosure.

Herein, the discussion is made by using a stereoscopic moving picture based on images captured by two adjacent cameras, however, the stereoscopic moving picture is not limited to this type of images but may be based on two frames of artificially generated dynamic images, and so on.

### FIRST EMBODIMENT

### Parallax

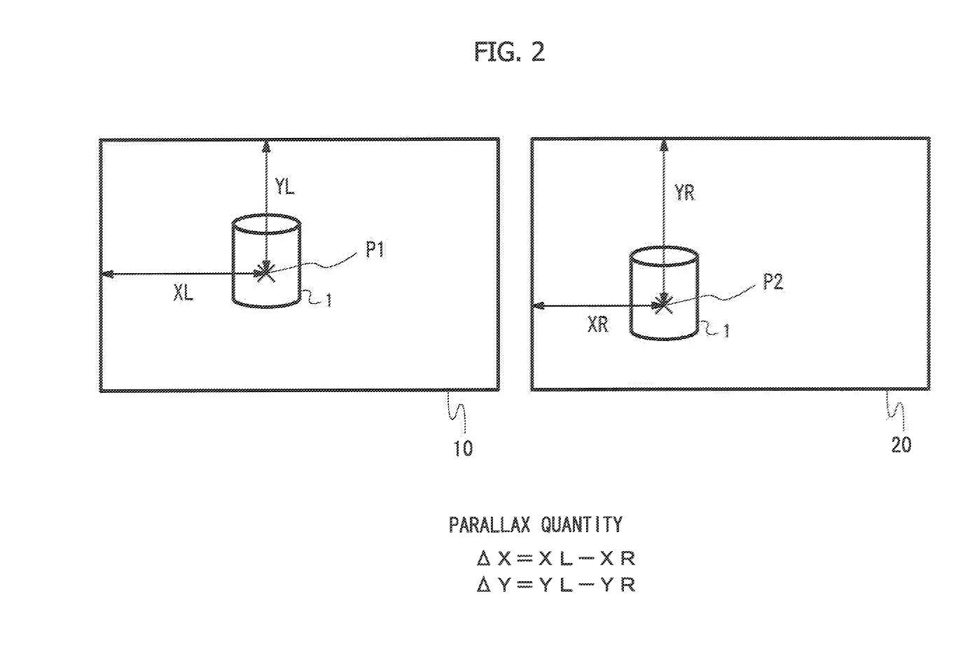

FIG. 2 is an explanatory diagram illustrating a parallax in the stereoscopic moving picture. In FIG. 2, for instance, in images of the same physical object captured by the two adjacent cameras, an image 10 is defined as an image for a left eye, while an image 20 is defined as an image for a right eye. In the example of FIG. 2, the image 10 and the image 20 contain an object 1 defined as the same physical object. Herein, a point P1 is set as a point representative of a position of the object 1 in the image 10. A point P2 is set as a point representative of a position of the object 1 in the image 20. The point representative of the position of the object 1 may be set to, e.g., a central point of the object 1 and also a point located at a rightward lower edge of the object 1. The point representative of the position of the object 1 is not limited to these points. The point P1 and the point P2 are points each indicating the same position of the object 1. The point P1 and the point P2 are also referred to as the position of the object 1 in the image 10 and as the position of the object 1 in the image 20, respectively.

The parallax in the stereoscopic moving picture is a difference between the position in the image for the left eye and the position in the image for the right eye with respect to the same physical object. A parallax quantity is a magnitude of the parallax.

In the image 10 and the image 20 of FIG. 2, the parallax quantity of the object 1 is a difference between the position (point P1) of the object 1 in the image 10 and the position (point P2)of the object 1 in the image 20. To be specific, let (XL, YL) be a coordinate of the point P1 in the image 10 and (XR, YR) be a coordinate of the point P2 in the image 20, and the parallax quantity of the object 1 is expressed as follows.

### [Mathematical Expression 1]

ΔX=XL−XR

ΔY=YL−YR

Herein, ΔX represents the parallax quantity in a crosswise direction, and ΔY denotes the parallax quantity in a lengthwise direction.

For example, the parallax of the object 1 in the stereoscopic moving picture disappears by moving the image for the right eye in parallel to a degree corresponding to this parallax quantity.

### Example of Data Structure

### MPEG2

Herein, an MPEG-2 (Moving Pictures Expert Group 2) format will be described.

According to the MPEG-2 format, the moving picture contains a plurality of images (static images) having time information. This moving picture is reproduced in a time sequence of the time information. Respective pieces of image data in the MPEG-2 format are compressed at intervals of a predetermined image data count (a predetermined number of frames).

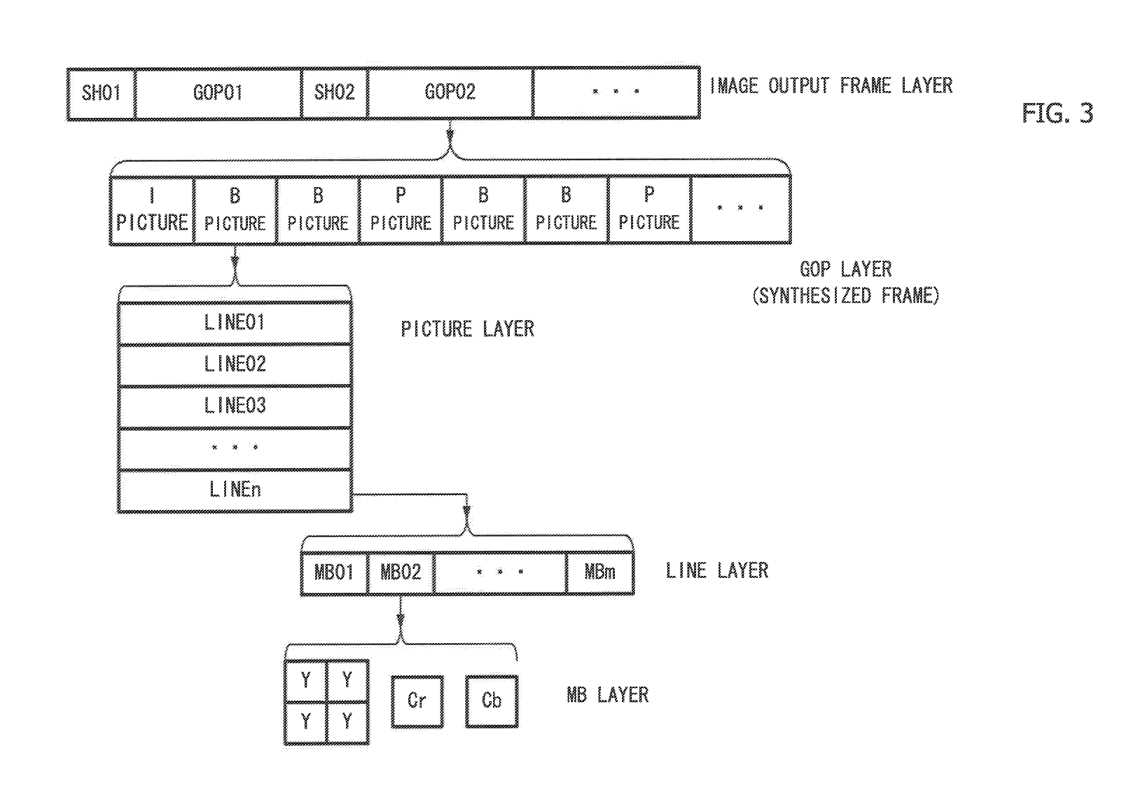

FIG. 3 is a diagram illustrating an example of a structure of MPEG-2 formatted data. The MPEG-2 formatted data in FIG. 3 takes a hierarchical structure. The MPEG-2 formatted data in FIG. 3 contains an image output frame layer, a GOP (Group of Pictures) layer, a picture layer, a line layer and an MB (Micro Block) layer.

The image output frame layer is the MPEG-2 formatted data corresponding to one video (one video sequence). The image frame layer contains a GOP (Group of Pictures) and an SH (Sequence Header). The image output frame layer contains a plurality of GOPs and a plurality of SHs.

The GOP is an aggregation of frames (pictures) needed for managing the frames efficiently. The frame is the minimum unit editable in the data of the moving pictures. The SH contains information such as a start point of the pictures of the GOP. The SH contains also time information and a frame rate.

The GOP layer includes an I-picture (Intra-coded picture) that is solely reproducible, a P-picture (Predicted picture) that is reproduced by use of the previous I-picture or P-picture, and a B-picture (Bi-directional Predicted picture) that is reproduced by use of the previous and forward I-picture or P-picture. The I-picture is the frame that is encoded for the first time. Decoding is started from the I-picture.

The picture layer includes a plurality of line blocks. In the example of FIG. 3, the picture layer includes n-pieces of line blocks. The number of the line blocks included in the picture layer depends on a size of the picture.

The line layer includes a plurality of macro blocks (MBs). The macro block contains luminance information (Y-information) and chrominance information (Cr information, Cb information).

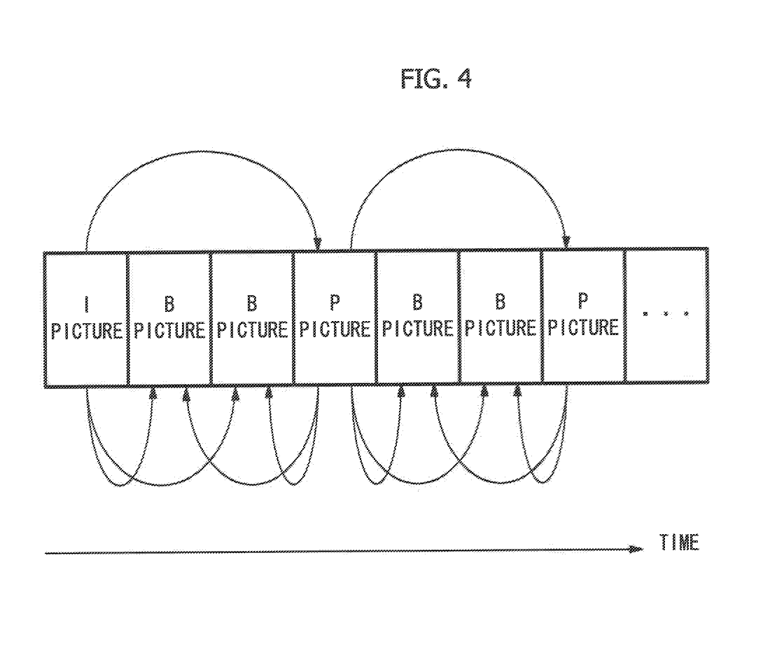

FIG. 4 is a diagram illustrating a relationship between, the I-picture, the P-picture and the B-picture. In the example of FIG. 4, the pictures become older (more previous) in terms of time in the sequence from the left-most picture. The I-picture is solely reproducible. The P-picture is reproduced by acquiring the information from the previous I-picture or P-picture. The B-picture is reproduced by acquiring the information from the previous I-picture or P-picture and from the forward P-picture. Herein, the information represents information about an intra-picture region (e.g., the macro block) and information about motion prediction (motion vector) of this region.

The data of the I-picture contains data of a moving image and data of a non-moving image. The data of the I-picture involves distinguishing between the moving image and the non-moving image. The non-moving image implies a background etc that does not change even the picture at a forward time next to this picture. The non-moving image is an image of the region in which the motion vector is zero vector. The moving image is an image containing a moving object etc in the picture at the forward time next to this picture. The moving image is an image of the region in which the motion vector is not the zero vector. The data of the P-picture contains the data of the moving image and the data of the non-moving image. The data of the P-picture involves distinguishing between the moving image and the non-moving image. The data of the B-picture contains the data of the moving image. That is, the data of the B-picture contains the image of the region in which the motion vector is not the zero vector. The data of each picture contains the data of the moving image. If any motion does not appear in the whole image, however, the data of each picture does not contain the data of the moving image.

### AVI

Herein, an AVI (Audio Video Interleave) format will be described.

According to the AVI format, the dynamic image contains the plurality of images (static images) having the time information. This dynamic image is reproduced in a time sequence of the time information. Each piece of image data in the AVI format is compressed on a per image data basis. The image data in the AVI format is solely reproducible as in the case of the I-picture explained earlier. Further, the image data does not involve distinguishing between the moving image and the non-moving image.

A difference between the image to be processed and the image at the time just previous to this image is taken, in which the region with the difference being “0” can be defined as the non-moving image, and the region with the difference not being “0” can be defined as the moving region (image). The difference between the timewise adjacent images is calculated beforehand, and, even when the moving image is AVI-formatted, the whole image can be separated into the moving image and the non-moving image. The moving image (region) and the non-moving image (region) may be calculated beforehand and stored in a storage unit etc.

### Configuration

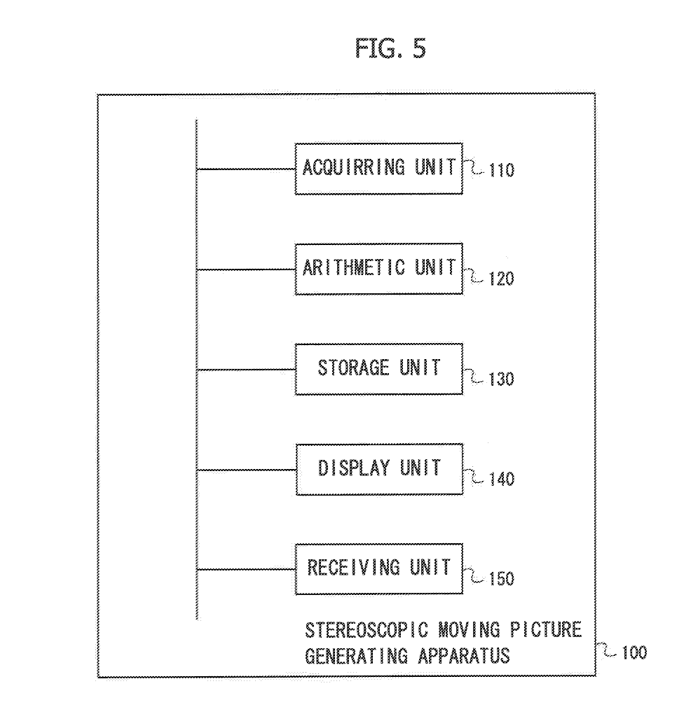

FIG. 5 is a diagram depicting an example of a stereoscopic moving picture generating apparatus. A stereoscopic moving picture generating apparatus 100 includes an acquiring unit 110, an arithmetic unit 120 and a storage unit 130.

The acquiring unit 110 acquires the dynamic images from an external or internal input device. The dynamic images acquired by the acquiring unit 110 are the dynamic image for the left eye and the dynamic image for the right eye in the stereoscopic moving picture. The dynamic images acquired by the acquiring unit 110 are stored in the storage unit 130. The dynamic image for the left eye and the dynamic image for the right eye are stored in the storage unit 130 in the way of being associated with each other. The dynamic image contains, e.g., the plurality of consecutive images (static images) attached with the time information. Each image contained in the dynamic image has a pixel value per dot within the image. The pixel value is information representing a color etc of the dot. The pixel values are expressed by, e.g., an R (Red) value, a G (Green) value and a B (Blue) value of RGB color coordinate system. As a substitute for the RGB color coordinate system, parameters (values) of other color coordinate systems (e.g., a YUV color coordinate system) may also be employed. In the case of using the parameters of the YUV color coordinate system, a Y (Yellow) value may be used as a luminance value.

The arithmetic unit 120 calculates the parallax quantity with respect to the images on a one-by-one basis, which are contained in the dynamic image acquired by the acquiring unit 110, thereby generating the stereoscopic moving picture. The stereoscopic moving picture generated by the arithmetic unit 120 is stored in the storage unit 130.

The storage unit 130 gets stored with the dynamic images acquired by the acquiring unit 110, the stereoscopic moving picture generated by the arithmetic unit 120, the parallax quantity calculated by the arithmetic unit 120, a reference object, and so on.

A display unit 140 displays the dynamic images etc stored in the storage unit 130.

A receiving unit 150 accepts an input such as a selection of the reference object from a user.

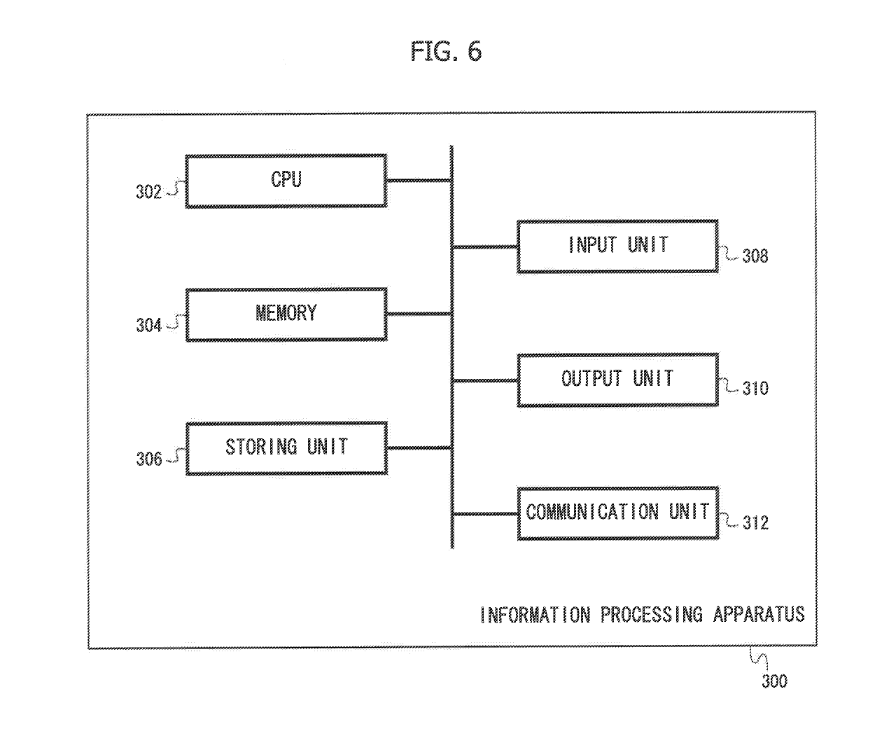

FIG. 6 is a diagram illustrating an example of a hardware configuration of an information processing apparatus 300. The stereoscopic moving picture generating apparatus 100 is realized by, e.g., the information processing apparatus 300 as depicted in FIG. 6. The information processing apparatus 300 includes a CPU (Central Processing Unit) 302, a memory 304, a storing unit 306, an input unit 308, an output unit 310 and a communication unit 312.

The CPU 302 loads a program stored in a recording unit 306 into an operation area of a memory 304 and executes this program, whereby the information processing apparatus 300 can actualize functions conforming to predetermined purposes by controlling peripheral devices through the execution of the program.

The CPU 302 performs processes according to the program stored in the storing unit 306. The memory 304 caches the program executed by the CPU 302 and the data processed by the CPU 302 and also deploys the operation area. The memory 304 includes, e.g., a RAM (Random Access Memory) and a ROM (Read Only Memory).

The storing unit 306 stores various categories of programs and various items of data on a readable/writable recording medium. The storing unit 306 is exemplified by a solid-state drive device, a hard disk drive device, a CD (Compact Disc) drive device, a DVD (Digital Versatile Disk) drive device, a +R/+RW drive device, an HD DVD (High-Definition Digital Versatile Disk) drive device or a BD (Blu-ray Disk) drive device. Furthermore, the recording medium is exemplified by a silicon disk including a nonvolatile semiconductor memory (flash memory), a hard disk, a CD, a DVD, a +R/+RW, an HD DVD or a BD. The CD is exemplified by a CD-R (Recordable), a CD-RW (Rewritable) and a CD-ROM. The DVD is exemplified by a DVD-R and a DVD-RAM (Random Access Memory). The BD is exemplified by a BD-R, a BD-RE (Rewritable) and BD-ROM.

The input unit 308 accepts an operating instruction etc from the user etc. The input unit 308 is exemplified by input devices such as a keyboard, a pointing device, a wireless remote controller, a microphone and a plurality of cameras. The CPU 302 is notified of information inputted from the input unit 308.

The output unit 310 outputs the data processed by the CPU 302 and the data stored in the memory 304. The output unit 310 is exemplified by output devices such as a CRT (Cathode Ray Tube) display, an LCD (Liquid Crystal Display, a PDP (Plasma Display Panel), an EL (Electroluminescence) panel, a printer and a loudspeaker.

The communication unit 312 transmits and receives the data to and from the external device. The communication unit 312 is connected to the external device via, e.g., a signal line. The communication unit 312 is exemplified such as a LAN (Local Area Network) interface board and a wireless communication circuit for wireless communications.

In the information processing apparatus 300, the storing unit 306 is stored with an operating system (OS), the various categories of programs and a variety of tables.

The OS is software that handles in-between operations between the software components and the hardware components, manages a memory space, manages files and manages processes and tasks. The OS includes a communication interface. The communication interface is defined as a program for transferring and receiving the data to and from the external device etc connected via the communication unit 312.

The information processing apparatus 300 capable of realizing the stereoscopic moving picture generating apparatus 100 actualizes functions as the acquiring unit 110, the arithmetic unit 120 and the receiving unit 150 in such a way that the CPU 302 loads the programs stored in the storing unit 306 into the memory 304 and executes the programs. Further, the storage unit 130 is provided in storage areas of the memory 304, the storing unit 306, etc. The display unit 140 is realized by the CPU 302, the output unit 310, etc. The receiving unit 150 is realized by the CPU 302, the input unit 308 and so on.

### Operation Example

An operation example of the stereoscopic moving picture generating apparatus 100 will be described. In the following discussion, the dynamic image for the left eye and the dynamic image for the right eye are employed, however, there is neither superiority nor inferiority between the dynamic image for the left eye and the dynamic image for the right eye, and the both are interchangeable. Similarly, the image for the left eye and the image for the right eye are used, however, there is neither superiority nor inferiority between the image for the left eye and the image for the right eye, and the both are interchangeable.

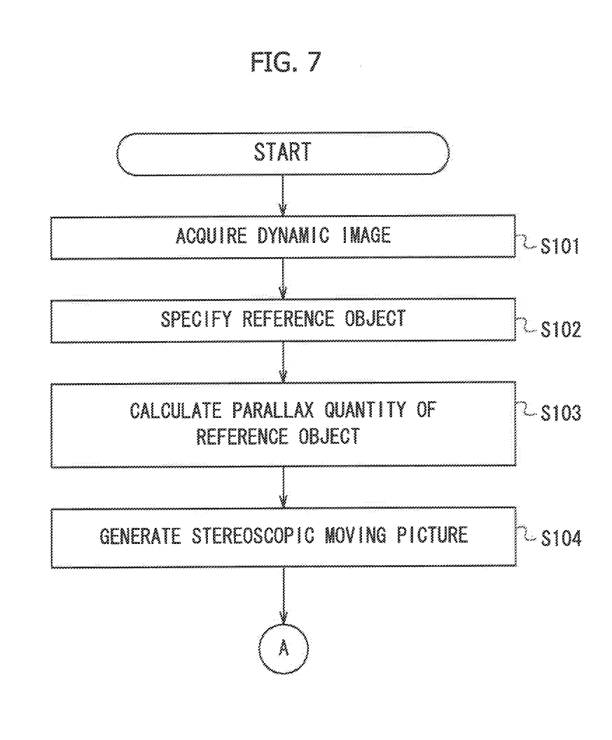

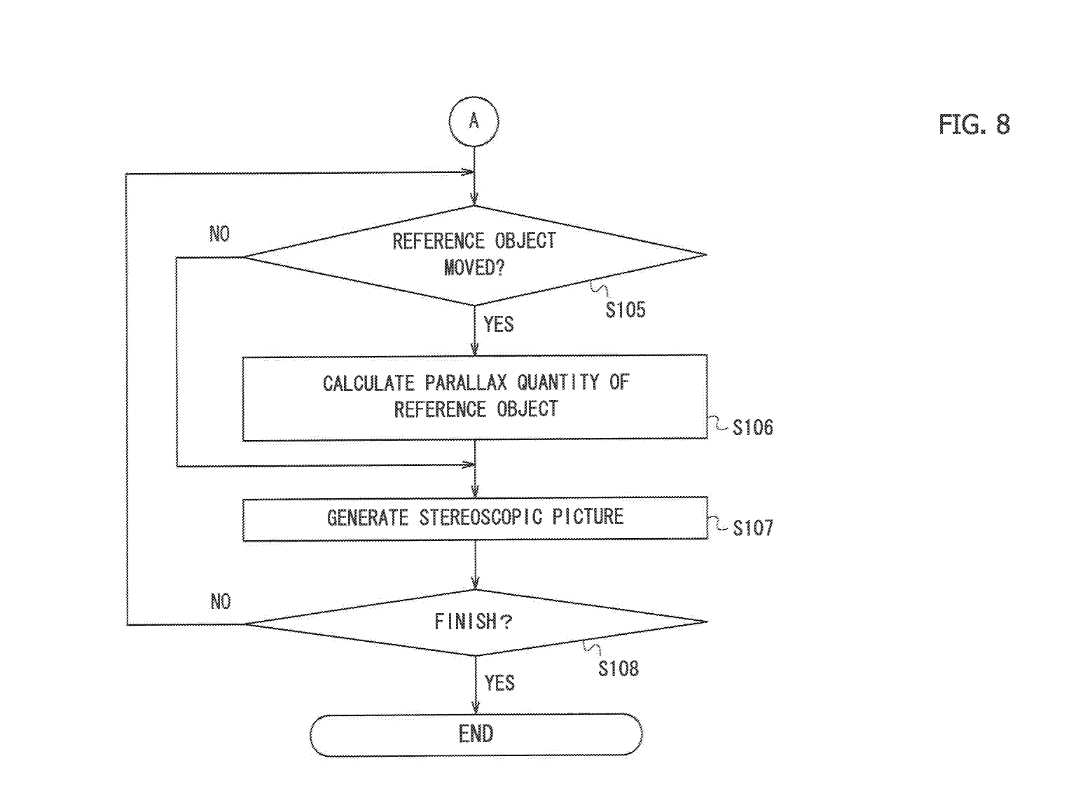

FIGS. 7 and 8 are flowcharts illustrating an example of an operation flow of the stereoscopic moving picture generating apparatus 100. A symbol [A] in FIG. 7 connects to [A] in FIG. 8. A start of the operation flow in FIG. 7 is triggered by, e.g., powering ON the stereoscopic moving picture generating apparatus 100.

The stereoscopic moving picture generating apparatus 100 acquires the dynamic image for the left eye and the dynamic image for the right eye, gets the reference object to be selected, and calculates the parallax quantity of the reference object of the top image. Moreover, the stereoscopic moving picture generating apparatus 100 moves, based on this parallax quantity, the whole image in parallel with respect to all of the images contained in the dynamic image (S101-S104). The dynamic image contains the plurality of consecutive static images (frames, pictures). Furthermore, the stereoscopic moving picture generating apparatus 100 calculates the parallax quantity of the reference object per static image, then moves the reference object in parallel on the basis of the parallax quantity, and adjusts the parallax quantity of the reference object (S105-S108). The stereoscopic moving picture generating apparatus 100 reproduces the images for the left eye and the images for the right eye, which are output as the post-adjusting images of the stereoscopic moving picture, normally in the timing sequence of the timing information. The dynamic images are compressed in, e.g., the MPEG-2 format. The processing of the stereoscopic moving picture generating apparatus 100 is not, however, limited to those processes.

The dynamic image for the left eye and the dynamic image for the right eye are associated with the timing information on the one-by-one basis of the image (static image) contained therein. The dynamic image for the left eye and the dynamic image for the right eye are associated with the time information in common per image contained therein. The association between the image and the time information is attained by each image having, e.g., the time information. Further, the association between the image and the time information is attained by, e.g., serial numbers given in the reproducing sequence and allocated to the respective images, the time information of the top image and a frame rate (an image count per unit time). Moreover, the association between the image and the time information is attained by, e.g., the respective images arranged in the reproducing sequence, the time information of the top image and the frame rate (the image count per unit time). Further, the time information of the top image may not be indispensable.

An in-depth description of the operation flow in FIGS. 7 and 8 will be made.

The acquiring unit 110 acquires the dynamic image for the left eye and the dynamic image for the right eye (S101). The acquiring unit 110 may acquire the dynamic image for the left eye and the dynamic image for the right eye from a camera built in the stereoscopic moving picture generating apparatus 100 and may also these images from the external device. The acquired dynamic image for the left eye and the acquired dynamic image for the right eye are stored in the storage unit 130. The dynamic image for the left eye and the dynamic image for the right eye may also be stored beforehand in the storage unit 130.

The arithmetic unit 120 specifies the object serving as the reference (reference object) (S102).

For example, the arithmetic unit 120 takes the image (the image for the left eye) with the timing of the timing information being earliest out of the acquired dynamic image for the left eye. Further, similarly, the arithmetic unit 120 takes out the image (the image for the right eye) with the timing of the timing information being earliest. The earliest timing of these pieces of timing information is the same. The image taken out herein is the top image of the dynamic image. The arithmetic unit 120 displays the taken-out image for the left and the taken-out image for the right eye on the display unit 140. The arithmetic unit 120 prompts the user to select a range serving as the reference object from the image displayed on the display unit 140. The user selects the range serving as the reference object from the image displayed on the display unit 140, and inputs the range selected through an accepting unit 150. The arithmetic unit 120 extracts the image in the selected range and stores the extracted image as the reference object in the storage unit 130. The arithmetic unit 120 is thereby enabled to specify the reference object. Moreover, the image as the reference object may also be previously stored in the storage unit 130. The range of the reference object may also be selected with respect to the image for the left eye and the image for the right eye, respectively. At this time, the user selects the range of the reference object about the same physical object with respect to the image for the left eye and the image for the right eye. The reference object is one example of a predetermined image.

The arithmetic unit 120 calculates the parallax quantity, between the image for the left eye and the image for the right eye, of the reference object specified in step S102 (S103). The arithmetic unit 120 takes the image (the image for the left eye) with the timing of the timing information being earliest out of the acquired dynamic image for the left eye. Furthermore, the arithmetic unit 120 takes out the image (the image for the right eye) with the timing of the timing information being earliest. Namely, the arithmetic unit 120 takes the first image for the left eye and the first image for the right eye out of the acquired dynamic image. The arithmetic unit 120 calculates the parallax quantity between the image for the left eye and the image for the right eye, i.e., between these images with the same timing information. The image to be processed herein is the image of the top I-picture in the dynamic image file taking, e.g., the MPEG-2 format. Further, the image to be processed herein is the top image in the dynamic image file taking, e.g., the AVI format.

The arithmetic unit 120 obtains a position of the reference object in the image for the left eye. Moreover, the arithmetic unit 120 obtains a position of the reference object in the image for the right eye. The position of the reference object in the image is, e.g., defined by coordinates of the center of the reference object. The reference objects of the image for the left eye and the image for the right eye are specified n step S102.

The arithmetic unit 120 can obtain the position of the reference object in the image for the left eye (or the image for the right eye) by performing pattern matching between the image of the reference object stored in the storage unit 130 and the image for the left eye (or the image for the right eye). The information on the position of the reference object in the image for the left eye (or the image for the right eye) is stored in the storage unit 130 in the way of being associated with the timing information.

The pattern matching is executed, e.g., as follows. The arithmetic unit 120 superposes the image for the left eye on the image of the reference object in a certain position, and takes a difference between the pixel values in the ranges of the reference objects of these two images. The arithmetic unit 120 similarly takes the difference in each of the positions by arbitrarily moving the reference object in parallel on the image for the left eye. The arithmetic unit 120 can set the position of the reference object with the difference being “0” or smaller than a predetermined value as the position of the reference object in the image for the left eye. The same is applied to the image for the right eye. Note that the pattern matching technique can involve, without being limited to the method described above, applying other known methods.

The arithmetic unit 120 calculates a difference between the position of the reference object in the image for the left eye and the position of the reference object in the image for the right eye. The thus-obtained difference becomes the parallax quantity. In the obtained difference, the difference given in the crosswise direction is a parallax quantity ΔX, while the difference given in the lengthwise direction is a parallax quantity ΔY. The arithmetic unit 120 stores the parallax quantity ΔX in the crosswise direction and the parallax quantity ΔY in the lengthwise direction in the storage unit 130.

Further, the arithmetic unit 120 may obtain the parallax quantity by superposing the image for the left eye and the image for the right eye on each other and moving one image (e.g., the image for the right eye) in parallel so that the range of the reference object specified in step S102 becomes coincident with the image for the left eye and the image for the right eye. The parallax quantity is equivalent to a distance (a moving quantity in an X-axis direction and a moving quantity in a Y-axis direction) at which one image (e.g., the image for the right eye) moves in parallel). At this time, the arithmetic unit 120 stores, with respect to the distance given when moved in parallel, the distance in the crosswise direction as the parallax quantity ΔX and the distance in the lengthwise direction as the parallax quantity ΔY in the storage unit 130. The parallax quantity contains positive and negative signs. That is, for instance, in the case of making the parallel movement in a −X direction, the parallax quantity ΔX takes a negative quantity.

Moreover, the arithmetic unit 120 may also obtain the parallax quantity as below. The arithmetic unit 120 displays the image for the left eye and the image for the right eye in superposition on the display unit 140. The user moves one image in parallel with the aid of the accepting unit 150 while looking at the images displayed on the display unit 140 so that the range of the reference object specified in step S102 becomes coincident with the image for the left eye and the image for the right eye. The parallax quantity becomes the distance given when one image (e.g., the image for the right eye) moves in parallel. The arithmetic unit 120 stores, with respect to the distance given when moved in parallel, the distance in the crosswise direction as the parallax quantity ΔX and the distance in the lengthwise direction as the parallax quantity ΔY in the storage unit 130.

The arithmetic unit 120 generates the stereoscopic moving picture (S104). In the process of S104, the arithmetic unit 120 takes, e.g., the dynamic image for the right eye out of the storage unit 130. Then, the arithmetic unit 120 sets, with respect to the images at all the timings in the dynamic image for the right eye, the image given when moving the whole image in parallel only by the parallax quantity as a new dynamic image for the right eye. The parallax quantities (ΔX and ΔY) stored in the storage unit 130 in step S103 are used as the parallax quantities. Thus, when moving the whole image of the dynamic image for the right eye in parallel only by the parallax quantities (ΔX and ΔY) obtained in the process of S103, the position of the reference object in the image for the right eye at the first timing of the image becomes coincident with the position of the reference object in the image for the left eye at the same timing. Namely, the parallax of the reference object between the image for the left eye and the image for the right eye at the first timing substantially disappears. The arithmetic unit 120 stores the dynamic image for the left eye and the new dynamic image for the right eye as the stereoscopic moving picture in the storage unit 130. The dynamic image for the left eye, which is stored herein, may also be referred to as the new dynamic image for the left eye. The dynamic image for the left eye and the dynamic image for the right eye, which are stored, can be displayed on a display device for the stereoscopic vision. The display device for the stereoscopic vision is a display device of such a type that the dynamic image for the left eye is inputted to the left eye, and the dynamic image for the right eye is inputted to the right eye. Further, the dynamic image for the left eye and the dynamic image for the right eye, which are stored, may also be displayed on the display unit 140.

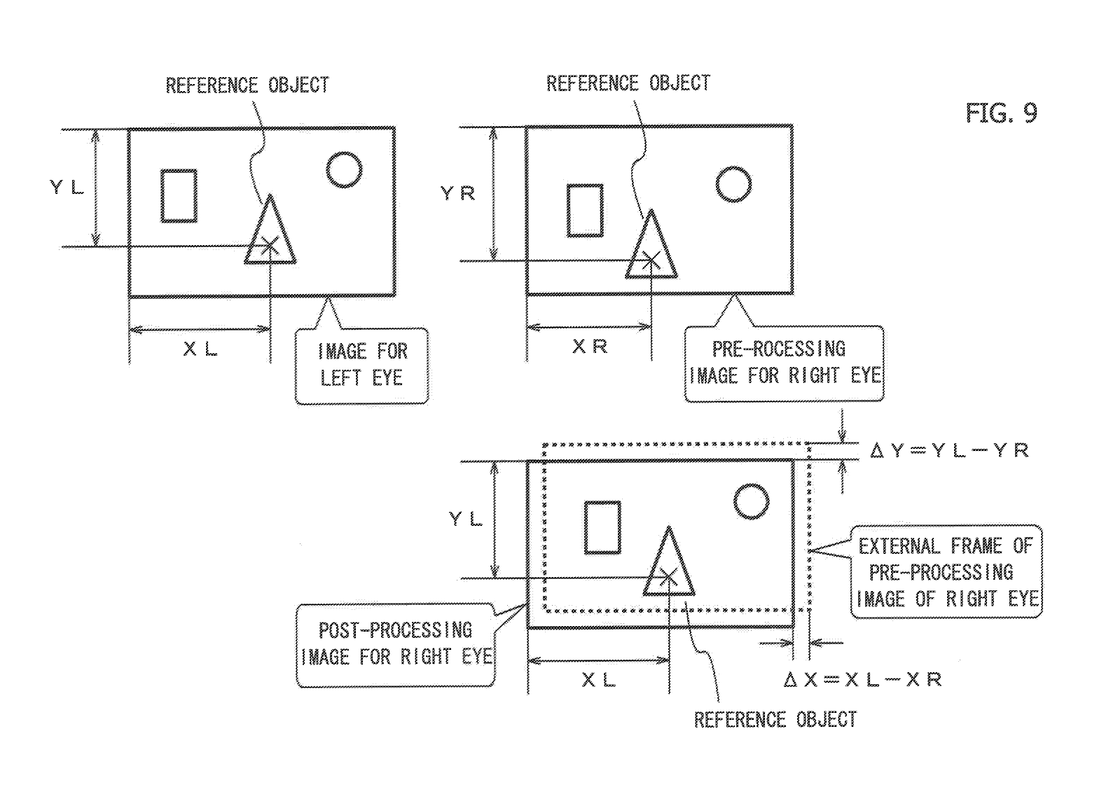

FIG. 9 is an explanatory diagram of the process in step S104. FIG. 9 depicts the image for the left eye at the first timing, a pre-processing image for the right eye at the first timing, and a post-processing image for the right eye at the first timing. Herein, an object taking a triangular shape in the vicinity of the center of each image in FIG. 9 is set as the reference object. A position of the reference object in the image for the left eye is specified by (XL, YL). A position of the pre-processing reference object in the pre-processing image for the right eye is specified by (XR, YR). Herein, the parallax quantity in the crosswise direction is given by ΔX=XL−XR, and the parallax quantity in the lengthwise direction is given by ΔY=YL−YR. Herein, when moving the image for the right eye in parallel only by the parallax quantity, the image becomes as in the post-processing image for the right eye. The position of the reference object in the post-processing image for the right eye is (XL, YL) and becomes coincident with the position of the reference object in the image for the left eye. A positional relationship between the pre-processing image for the right eye and the post-processing image for the right eye remains unchanged. That is, the distance in the crosswise direction and the distance in the lengthwise direction between the reference object and another object etc remain unchanged between the pre-processing image for the right eye and the post-processing image for the right eye.

Moreover, in the description given above, one whole image is moved in parallel and is set as the new image. Herein, with respect to the respective dynamic images (the dynamic image for the left eye, the dynamic image for the right eye), the arithmetic unit 120 may set the position of the reference object in the image for the left eye at the first timing to be coincident with the position of the reference object in the image for the right eye at the first timing by moving the whole images of the dynamic image in parallel by a quantity that is ½ of the parallax quantity of the reference object. Namely, the arithmetic unit 120, when letting ΔX and ΔY be the parallax quantities, sets a point, at which an X-coordinate and a Y-coordinate of the point of the image for the left eye are moved in parallel by −ΔX/2 and −ΔY/2, as a new point of the image for the left eye. Similarly, the arithmetic unit 120 sets a point, at which an X-coordinate and a Y-coordinate of the point of the image for the right eye are moved in parallel by +ΔX/2 and +ΔY/2, as a new point of the image for the right eye. Furthermore, the arithmetic unit 120 may move the whole image of the dynamic image in parallel by a quantity that is ⅓ of the parallax quantity of the reference object in one dynamic image and may move the whole image of the dynamic image in parallel by a quantity that is ⅔ of the parallax quantity of the reference object in another dynamic image. A ratio to the parallax quantity on the occasion of the parallel movement can be set without any restrictions. It is, however, required that each of the quantities of the parallel movements in the dynamic image for the left eye and the dynamic image for the right eye is coincident with the parallax quantity of the reference object on the whole. At this time, it follows that the arithmetic unit 120 generates the new dynamic image for the left eye and the new dynamic image for the right eye and stores the generated images in the storage unit 130.

The arithmetic unit 120 changes the information on the positions of the reference objects of the image for the left eye and the image for the right eye, which are stored in the storage unit 130 in step S103, in the way of taking account of the process in step S104.

In step S104, the images at all the timings in the dynamic image are processed based on the parallax quantities (ΔX and ΔY) obtained in step S103.

The subsequent processes involve using the dynamic image for the left eye and the dynamic image for the right eye, which are processed in step S104.

In step S105, the arithmetic unit 120 determines, based on the image (the image processed in immediate previous step S103 or immediate previous step S105) processed just previously and the image at the timing next to this image, whether the reference object moves or not (FIG. 8: S105). That is, the arithmetic unit 120 determines, based on the image for the left eye that is processed just previously and the image for the left eye at the timing next to this image, whether the reference object moves or not. Further, the arithmetic unit 120 determines, based on the image for the right eye that is processed just previously and the image for the right eye at the timing next to this image, whether the reference object moves or not.

The arithmetic unit 120 takes the images (the image for the left eye and the image for the right eye) at the timing next to the image processed just previously out of the storage unit 130. The thus taken-out images for the left eye and the right eye are already processed based on the parallax quantities calculated in step S103.

The arithmetic unit 120 obtains the position of the reference object in the taken-out image for the left eye. The arithmetic unit 120 stores the position of the reference object in the thus-obtained image for the left eye in the storage unit 130 in the way of being associated with the timing information. The reference object is specified in step S102. The arithmetic unit 120, similarly to the process in step S103, performs the pattern matching between the image of the reference object stored in the storage unit 130 and the image for the left eye, and is thereby enabled to obtain the position of the reference object in the image for the left eye. The arithmetic unit 120 calculates a distance between the position of the reference object that is obtained herein and the position of the reference object of the image for the left eye that is processed just previously. The arithmetic unit 120 processes the image for the right eye in the same way. The arithmetic unit 120, if the distance between the position of the reference object of at least one image in the images for the left eye and the right eye and the position of the reference object of the immediate previous image is equal to or larger than a predetermined value, determines that the reference object has moved. The arithmetic unit 120, if each of the distances between the positions of the reference objects of both of the image for the left eye and the image for the right eye and the position of the reference object of the immediate previous image is “0” or smaller than the predetermined value, determines that the reference object does not move.

Further, the arithmetic unit 120 may determine whether the reference object moves or not by determining whether or not the image of the reference object is contained in the moving image (region) contained in the data of the image at the timing next to the image processed just previously. This determination may involve using the pattern matching. The moving image (region) is the image containing the moving physical object etc. Hence, the moving image contains the image of the reference object, in which case the arithmetic unit 120 determines that the reference object keeps moving.

In the case of determining that the reference object keeps moving (S105; YES), the arithmetic unit 120 calculates the parallax quantity between the image for the left eye and the image for the right eye of the reference object with respect to the image for the left eye and the image for the right eye, which are taken out in step S105 (S106). The arithmetic unit 120 calculates the difference between the position of the reference object of the image for the left eye and the position of the reference object of the image for the right eye, which are obtained in step S105. This obtained difference becomes the parallax quantity given herein. In the obtained difference, the difference in the crosswise direction is defined as a parallax quantity ΔX1, and the difference in the lengthwise direction is defined as a parallax quantity ΔY1. The arithmetic unit 120 stores the parallax quantity ΔX1 in the crosswise direction and the parallax quantity ΔY1 in the lengthwise direction in the storage unit 130. Initial values of the parallax quantity ΔX1 and the parallax quantity ΔY1 are both “0”.

In the case of determining that the reference object does not move (S105; NO), the processing advances to step S107.

In step S107, the arithmetic unit 120 generates the stereoscopic picture (S107). The arithmetic unit 120 sets, with respect to the taken-out image for the right eye, the image of the reference object moved in parallel by the parallax quantity ΔX1 and the parallax quantity ΔY1 each stored in the storage unit 130 in the X-axis (crosswise) direction and the Y-axis (lengthwise) direction as a new image for the right eye. The parallax quantity involves employing the parallax quantities (ΔX1 and ΔY1) stored in the storage unit 130. When the reference object of the image for the right eye is moved in parallel by the parallax quantities (ΔX1 and ΔY1), the position of the reference object in the image for the right eye gets coincident with the position of the reference object in the image for the left eye at the same timing. Namely, the parallax of the reference object between the image for the left eye and the image for the right eye substantially disappears. The arithmetic unit 120 stores the dynamic image for the left eye and the new dynamic image for the right eye as one set (one pair) of images of the stereoscopic moving picture in the storage unit 130 in the way of being associated with the timing information of the images processed in step S105. The parallax quantities of the portions other than the reference object are not changed. The image for the left eye, which is stored herein, may be referred to as the new image for the left eye.

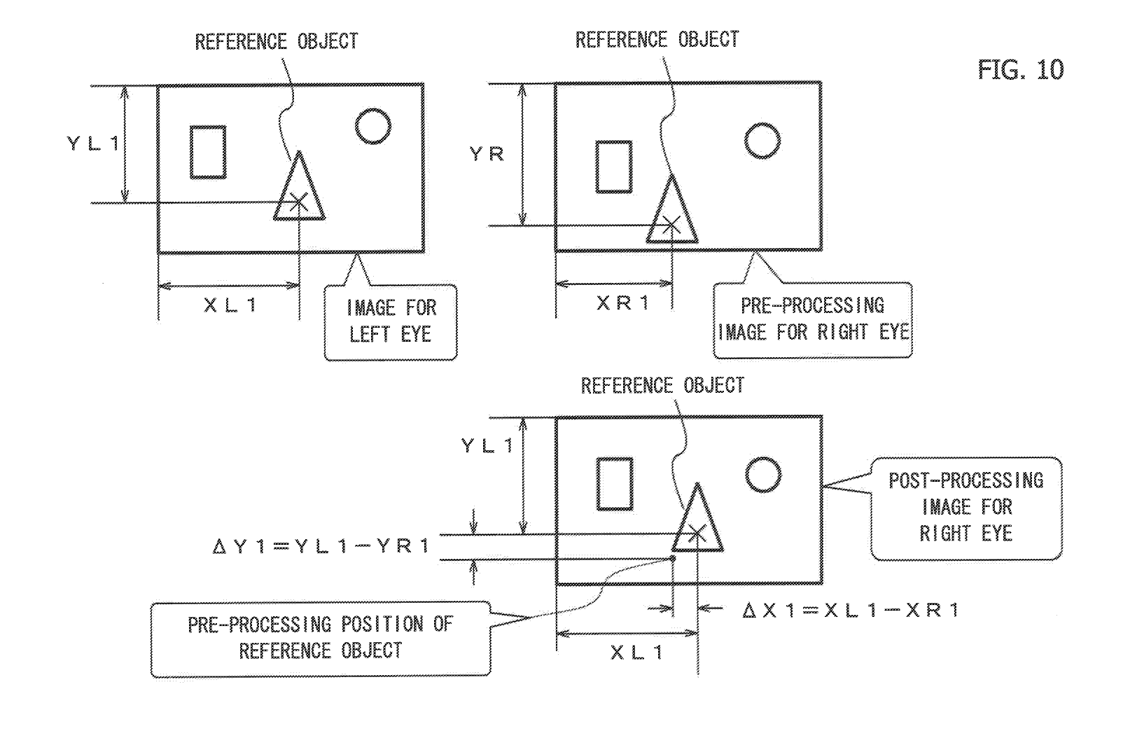

FIG. 10 is an explanatory diagram of the process in step S107. FIG. 10 depicts the image for the left eye, the pre-processing image for the right eye and the post-processing image of the right eye. Herein, an object taking a triangular shape in the vicinity of the center of each image in FIG. 10 is set as the reference object. A position of the reference object in the image for the left eye is specified by (XL1, YL1). A position of the pre-processing reference object in the pre-processing image for the right eye is specified by (XR1, YR1). The parallax quantity of the reference object in the crosswise direction is given by ΔX1=XL1−XR1, and the parallax quantity in the lengthwise direction is given by ΔY1=YL1−YR1. Herein, when moving the reference object in the image for the right eye in parallel only by the parallax quantities (ΔX1 in the crosswise direction, ΔY1 in the crosswise direction), the image becomes as in the post-processing image for the right eye. The position of the reference object in the post-processing image for the right eye is (XL1, YL1) and becomes coincident with the position of the reference object in the image for the left eye. The positions of the objects etc exclusive of the reference object are not changed between the pre-processing image for the right eye and the post-processing image for the right eye. That is, for example, the positions of the objects taking a quadrangular shape and a circular shape are not changed between the pre-processing image for the right eye and the post-processing image for the right eye.

Furthermore, in the description given above, one image is moved in parallel and is set as the new image. Herein, in the respective images (the image for the left eye, the image for the right eye), the arithmetic unit 120 may set the position of the reference object to be coincident with respect to the right eye and the image for the right eye by moving the reference object of the image in parallel by quantities that are ½ of the parallax quantities (ΔX1 and ΔY1) of the reference object. Namely, the arithmetic unit 120, when letting ΔX1 and ΔY1 be the parallax quantities, sets a point, at which an X-coordinate and a Y-coordinate of the point of the reference object of the image for the left eye are moved in parallel by −ΔX½ and −Y½, as a new point of the reference object of the image for the left eye. Similarly, the arithmetic unit 120 sets a point, at which an X-coordinate and a Y-coordinate of the point of the reference object of the image for the right eye are moved in parallel by +ΔX½ and +ΔY½, as a new point of the reference object of the image for the right eye. Furthermore, the arithmetic unit 120 may move the reference object in parallel by a quantity that is ⅓ of the parallax quantity of the reference object in one dynamic image and may move the reference object in parallel by a quantity that is ⅔ of the parallax quantity of the reference object in another dynamic image. A ratio to the parallax quantity on the occasion of the parallel movement can be set without any restrictions. It is, however, required that each of the quantities of the parallel movements in the dynamic image for the left eye and the dynamic image for the right eye is coincident with the parallax quantity of the reference object on the whole. This is because if not coincident with the parallax quantity of the reference object on the whole, the position of the reference object is not coincident with respect to the image for the left eye and the image for the right eye. At this time, it follows that the arithmetic unit 120 generates the new image for the left eye and the new image for the right eye and stores the generated images as one set (one par) of images of the stereoscopic moving picture in the way of being associated with the timing information of the images processed in step S105 in the storage unit 130.

The arithmetic unit 120 checks whether or not there exists the image having the timing of the timing information next to the timing of the timing information of the image processed in step S105. That is, the arithmetic unit 120 determines whether the image processed in step S105 is the last image or not (S108). If the image processed in step S105 is the last image (S108; YES), the arithmetic unit 120 finishes processing. Whereas if the image processed in step S105 is not the last image (S108; NO), the arithmetic unit 120 loops the processing back to step S105.

In the example given above, the contrivance is that the position of the reference object in the image for the right eye of the images becomes coincident with the position of the reference object in the image for the left eye at the same timing. Herein, the predetermined positional relationship between the position of the reference object in the image for the right eye of the images and the position of the reference object in the image for the left eye at the same timing may be kept in a predetermined range. For example, the position of the reference object in the image for the right eye of the images and the position of the reference object in the image for the left eye at the same timing may maintain the parallax quantities (ΔX and ΔY) calculated in step S103. In the case of maintaining the parallax quantities (ΔX and ΔY) calculated in step S103, the parallel movement may not be conducted in step S104.

### Operation, Effect of Embodiment

The stereoscopic moving picture generating apparatus 100, with respect to the dynamic image for the left eye and the dynamic image for the right eye at the first timing, sets the parallax quantity between the image for the left eye and the image for the right eye of the reference object to be smaller than the predetermined value or within the predetermined range by moving the whole images in parallel. The stereoscopic moving picture generating apparatus 100, if the reference object moves, sets the parallax quantity of the reference object to be smaller than the predetermined value or within the predetermined range by moving the reference object in parallel.

The stereoscopic moving picture generating apparatus 100, after setting the parallax quantity of the reference object to be smaller than the predetermined value or within the predetermined range with respect to the image at the first timing, does not change the parallax quantity about the portions other than the reference object between the dynamic image for the left eye and the dynamic image for the right eye.

According to the stereoscopic moving picture generating apparatus 100, it is feasible to keep the parallax quantity of the reference object between the dynamic image for the left eye and the dynamic image for the right eye smaller than the predetermined value or within the predetermined range without changing a stereoscopic sense of the region other than the reference object even when the reference object moves in a depthwise direction. The stereoscopic moving picture generating apparatus 100 is capable of dynamically adjusting the parallax quantity between the dynamic image for the right eye and the dynamic image for the left eye.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has(have) been described in detail, it should be understood that the various changes, substitutions, and alterations could be made hereto without departing from the spirit and scope of the invention.

What is claimed is:

1. A stereoscopic moving picture generating apparatus comprising:
a storage unit to store a first dynamic image containing a plurality of images each associated with timing information, a second dynamic image containing a plurality of images each associated with the timing information, and a predetermined image; and
an arithmetic unit to extract a first image of the first dynamic image and a second image of the second dynamic image, which are associated with the same timing information, and the predetermined image from the storage unit, calculate a first position as an existing position of the predetermined image in the first image, calculate a second position as an existing position of the predetermined image in the second image, calculate a first differential quantity as a difference between the first position and the second position, move at least one of the first position of the predetermined image in the first image and the second position of the predetermined image in the second image in parallel on the basis of the first differential quantity, and thus generate a new first image and a new second image.

2. The stereoscopic moving picture generating apparatus according to claim 1, wherein the arithmetic unit extracts, before generating a new first image and a new second image, a third image of the first dynamic image with a timing of the timing information being the top timing and a fourth image of the second dynamic image with a timing of the timing information being the top timing from the storage unit, calculates a third position as the existing position of the predetermined image in the third image, calculates a fourth position as the existing position of the predetermined image in the fourth image, calculates a second differential quantity as a difference between the third position and the fourth position, moves each of the whole images in parallel on the basis of the second differential quantity with respect to at least one set of entire images contained in the first dynamic image or another set of entire images contained in the second dynamic image, thus generates the new first dynamic image and the new second dynamic image, and stores the new first dynamic image as the first dynamic image and the new second dynamic image as the second dynamic image in the storage unit.

3. A stereoscopic moving picture generating method by which a computer executes:
extracting a first image of the first dynamic image and a second image of the second dynamic image, which are associated with the same timing information, and a predetermined image from a storage unit stored with a first dynamic image containing a plurality of images each associated with timing information, a second dynamic image containing a plurality of images each associated with the timing information and the predetermined image;
calculating a first position as an existing position of the predetermined image in the first image, calculating a second position as an existing position of the predetermined image in the second image, calculating a first differential quantity as a difference between the first position and the second position, moving at least one of the first position of the predetermined image in the first image and the second position of the predetermined image in the second image in parallel on the basis of the first differential quantity, and thus generating a new first image and a new second image.

4. The stereoscopic moving picture generating method according to claim 3, wherein the computer further executes:
extracting, before generating a new first image and a new second image, a third image of the first dynamic image with a timing of the timing information being the top timing and a fourth image of the second dynamic image with a timing of the timing information being the top timing from the storage unit; and
calculating a third position as the existing position of the predetermined image in the third image, calculating a fourth position as the existing position of the predetermined image in the fourth image, calculating a second differential quantity as a difference between the third position and the fourth position, moving each of the whole images in parallel on the basis of the second differential quantity with respect to at least one set of entire images contained in the first dynamic image or another set of entire images contained in the second dynamic image, thus generating the new first dynamic image and the new second dynamic image, and storing the new first dynamic image as the first dynamic image and the new second dynamic image as the second dynamic image in the storage unit.

5. A computer-readable recording medium having stored therein a stereoscopic moving picture generating program to make a computer execute:
extracting a first image of the first dynamic image and a second image of the second dynamic image, which are associated with the same timing information, and a predetermined image from a storage unit stored with a first dynamic image containing a plurality of images each associated with timing information, a second dynamic image containing a plurality of images each associated with the timing information and the predetermined image;
calculating a first position as an existing position of the predetermined image in the first image, calculating a second position as an existing position of the predetermined image in the second image, calculating a first differential quantity as a difference between the first position and the second position, moving at least one of the first position of the predetermined image in the first image and the second position of the predetermined image in the second image in parallel on the basis of the first differential quantity, and thus generating a new first image and a new second image.

6. The computer-readable recording medium having stored therein the stereoscopic moving picture generating program according to claim 5, further making the computer execute:
extracting, before generating a new first image and a new second image, a third image of the first dynamic image with a timing of the timing information being the top timing and a fourth image of the second dynamic image with a timing of the timing information being the top timing from the storage unit; and
calculating a third position as the existing position of the predetermined image in the third image, calculating a fourth position as the existing position of the predetermined image in the fourth image, calculating a second differential quantity as a difference between the third position and the fourth position, moving each of the whole images in parallel on the basis of the second differential quantity with respect to at least one set of entire images contained in the first dynamic image or another set of entire images contained in the second dynamic image, thus generating the new first dynamic image and the new second dynamic image, and storing the new first dynamic image as the first dynamic image and the new second dynamic image as the second dynamic image in the storage unit.
